(19) United States
(12) Patent Application Publication
(10) Pub. No.: US 2021/0147277 A1
(43) Pub. Date: May 20, 2021

(54) METHOD AND DEVICE FOR BENDING SHEETS

(71) Applicant: SAINT-GOBAIN GLASS FRANCE, COURBEVOIE (FR)

(72) Inventors: Arthur PALMANTIER, Aachen (DE); Achim ZEICHNER, Herzogenrath (DE); Jack PENNERS, Übach-Palenberg (DE)

(21) Appl. No.: 17/252,954

(22) PCT Filed: Oct. 28, 2019
(86) PCT No.: PCT/EP2019/079321

§ 371 Date: Dec. 16, 2020

(30) Foreign Application Priority Data
Oct. 31, 2018 (EP) 18203721.8

(51) Int. Cl. C03B 23/03; C03B 23/023

(52) U.S. Cl. CPC C03B 23/0307; C03B 23/0302; C03B 23/0235

(57) ABSTRACT

A method for bending sheets, in which a sheet is fixed in a bending chamber on a contact surface of a mold and is placed by the mold onto a frame, wherein the mold is introduced into the bending chamber before the fixing of the sheet in the bending chamber, without the fixed sheet, and is removed from the bending chamber after the placing of the sheet onto the frame, without the fixed sheet.

The invention is in the technical area of the production of sheets and relates to a method and a device for bending sheets.

Various bending methods, many of which have already found their way into the patent literature, are used in the industrial series production of glass panes.

For example, WO 2012/080072 describes a method with incremental bending of glass panes in the edge region and the inner region. Here, the glass pane is first moved on a pre-bending ring into a furnace, wherein the pane edge is pre-bent, followed by further bending of the pane edge by a first suction device, placing and bending the glass pane in the surface on a final bending ring and finish bending to the desired final geometry by means of a second suction device.

In WO 2004/087590 and WO 2006072721, in each case, a method is described in which the glass pane is first pre-bent by gravity on a bending frame, followed by press bending using an upper or lower mold.

EP 255422 and U.S. Pat. No. 5,906,668 describe in each case the bending of a glass pane by suction against an upper mold.

EP 1550639 A1, US 2009/084138 A1, and EP 2233444 A1 disclose in each case a device in which a press frame can be transported between bending stations on a slide that is displaceably mounted on a stationary carrier.

WO 2007/050297 A2 discloses a device for bending glass, in which the sheet is heated to bending temperature in a heating zone. Then, the heated sheet is lifted by a transport plate and conveyed from the heating zone into a bending chamber and placed on a press ring there. The sheet is then press molded by a bending mold. An analogous device can be found in U.S. Pat. No. 4,662,925 A.

Generally, there is a need for relatively compact systems for bending glass panes, wherein the glass pane should be producible with relatively short cycle times and low production costs. In addition, complexly bent sheets with very high quality requirements should be producible, which, with a view to avoiding optical defects, can usually only be realized by multi-stage sheet bending and requires the use of multiple molds. The provision of such systems for bending glass panes is complex and cost intensive such that it would be desirable to be able to continue to use existing systems. In addition, the systems should be quickly and cost-effectively adaptable to changed requirements for the bending process.

These and other objects are accomplished according to the proposal of the invention by a method and a device for bending glass panes with the features of the coordinate claims. Advantageous embodiments of the invention are apparent from the dependent claims.

The term “sheet” refers generally to a glass pane, in particular a thermally tempered soda lime glass.

The term “pre-bending” refers to an incomplete bending of the sheet relative to a defined or definable final bending (final geometry or final shape) of the sheet. The pre-bending can, for example, account for 10% to 80% of the final bending. When used as “edge pre-bending”, the term refers to the incomplete bending of the sheet in a peripheral edge region of the sheet adjacent a sheet edge, typically an edge region surrounding the sheet in a strip-like manner. For example, the strip width is in the range from 3 mm to 150 mm. The sheet edges are in each case formed by an end surface that is typically perpendicular to the two opposite primary surfaces of the sheet. When used as “surface pre-bending”, the term refers to the incomplete bending of the sheet in a central or inner region of the sheet, which is surrounded by the edge region and is directly adjacent the edge region. In contrast, the term “final bending” refers to complete bending of the sheet. When used as “edge final bending”, the term refers to the complete bending in the edge region of the sheet; when used as “surface final bending”, to the complete bending in the inner region of the sheet.

The device according to the invention for bending sheets comprises a bending chamber for bending heated sheets, which is advantageously equipped with a heating device for heating sheets. In particular, for this purpose, the bending chamber can be brought to a temperature (softening temperature), enabling plastic deformation of sheets and, for glass, typically being in the range from 600° C. to 800° C. The bending chamber has a bending chamber cavity, which is completely enclosed by a preferably insulated wall. The bending chamber cavity has at least one opening that opens into the bending chamber cavity, which can preferably be closed by a bending chamber door.

At least one stationary (positionally fixed) mold with a contact surface for fixing a sheet is arranged in the bending chamber. As used here and in the following, the term “stationary mold” refers to a mold, which, at least during the period in which one and the same sheet is situated in the bending chamber, is neither introduced into the bending chamber nor removed from the bending chamber, but, instead, remains permanently (uninterruptedly) in the bending chamber. Typically, the stationary mold remains permanently in the bending chamber at least during the time from the provision of a sheet to be processed in the bending chamber until the transporting of the sheet on a frame-shaped carrier (tempering frame) from the bending chamber to a cooling device (situated outside the bending chamber). The stationary mold is movable within the bending chamber. Preferably, but not mandatorily, the bending chamber includes only a single stationary mold.

In addition to the stationary mold, which remains permanently in the bending chamber during the processing of a sheet in the bending chamber, the device for bending sheets includes at least one transportable mold with a contact surface for fixing a sheet. As used here and in the following, the term “transportable mold” refers to a mold, which, during the period of time in which one and the same sheet is situated in the bending chamber, is not permanently arranged in the bending chamber, but is, at times, also situated outside the bending chamber and is introduced into the bending chamber without a sheet fixed on the transportable mold and is removed from the bending chamber without a sheet fixed on the transportable mold. The introduction of the transportable mold into the bending chamber as well as the removal of the transportable mold from the bending chamber is thus always done without a sheet fixed on the transportable mold. Fixing a sheet on the transportable mold is done exclusively within the bending chamber, but not outside the bending chamber, in particular not in a preheating zone that serves to heat the sheets to a temperature suitable for bending (softening temperature of glass). In this respect, the transportable mold does not serve for the transport of a sheet into the bending chamber or out of the bending chamber. In other words, the transportable mold is introduced into the bending chamber and removed from the bending chamber without a sheet fixed on the transportable mold between the fixing of a sheet on the stationary mold in the bending chamber and the immediately following fixing of another sheet on the stationary mold in the bending chamber, i.e., between the immediately successive fixing of two sheets on the stationary mold in the bending chamber. The transportable mold is fastened, preferably immovably, on a movable mold carrier. The mold carrier is arranged relative to the bending chamber such that the transportable mold can be introduced into the bending chamber and can be removed from the bending chamber by moving the mold carrier. Preferably, movement of the transportable mold into the bending chamber (without a sheet fixed thereon) and out of the bending chamber (without a sheet fixed thereon) is exclusively horizontal. Equally preferably, movement of the transportable mold within the bending chamber with a sheet fixed on the transportable mold is exclusively vertical.

The stationary mold and the transportable mold serve in each case for shaping sheets, wherein each mold has a contact surface which generally serves for fixing a sheet and, optionally, for pressing (compression molding) the sheet in cooperation with a frame-shaped (sheet) carrier, for example, annular carrier, hereinafter referred to as “frame”. In particular, the transportable mold can also serve, in cooperation with the press frame, for compression molding a sheet. The term “fixing” refers to the fixing of a sheet on the contact surface of a mold, wherein the sheet can be pressed against the contact surface and/or attracted by the contact surface, in particular sucked. Typically, the contact surface of a mold is implemented such that a sheet can achieve a desired bend in a bending process comprising multiple stages (bending operations). The contact surface has an outer surface section and an inner surface section or is composed of the outer and inner surface section. Preferably, the outer surface section of the contact surface is suitably designed for edge final bending edge final bending in an edge region of the sheet. Preferably, the inner surface section is suitably designed for surface pre-bending or surface final bending in a central or inner region of the sheet surrounded by the edge region. The phrase “suitably designed”, in connection with the outer surface section of the contact surface, means that the outer surface section is shaped such that edge final bending of the sheet can be produced by abutment against the outer surface section or pressing a sheet. However, the sheet does not mandatorily have to be subjected to edge final bending; instead, edge pre-bending alone can also be done. In this case, the edge final bending is not generated until the further course of the method. For this purpose, the outer surface section does not mandatorily have to have a shape complementary to the shape of an edge final bent sheet. In connection with the inner surface section of the contact surface, “suitably designed” means that the inner surface section, for example, is shaped such that surface pre-bending of the sheet can be produced by abutment against the inner surface section or pressing, whereby surface pre-bending does not mandatorily have to be done. If the inner surface section is suitably designed for surface final-bending, this means that surface final bending can be produced, but does not mandatorily have to be produced. It is also possible for the surface final bending to not be produced until the further course of the method. The fixing of a sheet on the contact surface can, but does not mandatorily have to, be associated with a bending operation of the sheet. The contact surface of a mold is oriented downward in the working position.

Pre-bending is not limited to one direction (cylindrical pre-bending). Rather, pre-bending can also be done in multiple directions different from one another.

Preferably, the at least one mold carrier is attached to a module arranged outside the bending chamber, referred to in the following as “mold carrier module” for easier reference and for differentiation from the “press frame module” mentioned below. The mold carrier module forms a structural unit and is preferably, but not mandatorily, movable relative to the bending chamber such that it can be delivered to the bending chamber and spatially removed from the bending chamber. The mold carrier module has, for this purpose, an actively or passively drivable movement mechanism for moving the mold carrier module relative to the bending chamber, for example, a roller transport mechanism or an air cushion transport mechanism.

Preferably, the mold carrier module includes a heatable cavity, referred to in the following as “mold carrier module cavity”, which is at least partially, in particular completely, delimited by a preferably insulated wall. The mold carrier module cavity has at least one opening, which is preferably closable by a door or flap. When the mold carrier module is delivered to the bending chamber, the mold carrier module cavity is spatially connected to the bending chamber cavity, whereby the mold carrier module cavity has at least one first opening, which can be brought into a position opposite a second opening of the bending chamber cavity of the bending chamber such that a preferably aligned connection of the mold carrier module cavity and the bending chamber cavity can be established. Preferably, the first opening of the mold carrier module cavity and/or the second opening of the bending chamber cavity are in each case provided with a door by which the associated opening can be closed. The spatial connectivity of the mold carrier module cavity and the bending chamber cavity is essential.

The mold carrier module cavity serves for receiving the transportable mold fastened to the mold carrier, in particular in order to heat the transportable mold to a temperature suitable for sheet processing before it is introduced into the bending chamber. In this way, the processing of sheets in the bending chamber can be carried out very quickly, without requiring time-consuming heating of the transportable mold within the bending chamber.

The mold carrier module is or can be delivered to the bending chamber such that the transportable mold can be moved into the bending chamber or out of the bending chamber by moving the mold carrier, with this movement preferably including at least one horizontal movement component. Preferably, the mold carrier is moved reciprocally and translationally (only) in a horizontal plane (i.e., one-dimensionally), in order to move the transportable mold into the bending chamber and out of the bending chamber. Preferably, the mold carrier is also vertically movable, in particular in order to move the transportable mold vertically within the bending chamber. For this purpose, the mold carrier is coupled with a movement mechanism. If a heatable mold carrier module cavity is provided, it is particularly advantageous for the mold carrier movement mechanism to be arranged at least partially, in particular completely, outside the heatable mold carrier module cavity. Thus, undesirable heating of components of the mold carrier movement mechanism and associated thermally induced changes in length can advantageously be avoided. This contributes significantly to positioning the mold carrier and in particular the transportable mold fastened thereon with particularly great accuracy and high speed within the bending chamber such that complexly shaped sheets can be produced with particularly high quality requirements. Preferably, the mold carrier can be actively cooled by a cooling device, by which means the positioning accuracy of the transportable mold can be further improved.

The mold carrier module is a self-contained structural unit that enables simple mounting of a mold as well as quick mold replacement independently of the bending chamber, in particular due to the capability of moving the mold carrier to the outside. When the mold carrier module is movable, the mold carrier module can be delivered to the bending chamber and removed again in a simple manner. This also advantageously provides free access to the bending chamber for performing maintenance or adjustments for a specific bending operation.

According to one embodiment, the device for bending sheets includes a press frame (e.g., a press ring) with a press surface for pressing a sheet. Preferably, the press surface of the press frame is designed complementary to the outer surface section of the stationary and/or transportable mold suitably designed for edge final bending. The press surface is, for example, designed in the form of a strip, with a strip width, for example, in the range from 3 to 150 mm. The press surface of the press frame is oriented upward for contact with a sheet. With a view to better weight distribution, a greater width of the strip-shaped press surface is advantageous in terms of avoiding undesirable markings (changes in the flat surfaces of the sheet), wherein the production of markings can be counteracted by pressing the sheet in the edge region on the press frame. The press surface of the press frame has a defined geometry, with the press frame being sufficiently rigid for this. The press frame is, for example, implemented as a cast part, with the press surface, for example, produced by milling.

The press frame is preferably suitably designed for surface pre-bending by gravity in the inner region of the sheet, wherein downward sagging of the inner region of the sheet due to gravity is possible. In the case of gravity bending, the sheet is pre-bent by its own weight. The press frame can, for this purpose, be open, i.e., be provided with a central opening, or be concave over its entire surface, so long as sagging of the inner region of the sheet is enabled. An open design is preferred with a view to simpler processing. As a result of the previous pressing of the sheet edge against the press surface of the press frame, the surface pre-bending of the sheet during storage on the press frame can be reduced.

In the device according to the invention for bending sheets, the molds (stationary mold and the at least one transportable mold) and the press frame are in each case vertically movable relative to one another such that a sheet can be pressed between the contact surface of a respective mold and the press surface of the press frame. The sheet is thus pre-bent or final bent in the edge region. Advantageously, the stationary mold is coupled with a movement mechanism by which the mold can be delivered to the stationary press frame in order to press a sheet. Preferably, the transportable mold can be delivered by moving the mold carrier vertically downward to the stationary press frame in order to press a sheet. Preferably, movement of the transportable mold with a sheet fixed there on is exclusively vertical. By the bending of a sheet in the edge and the inner region carried out in multiple stages, complexly shaped sheets with particularly high quality can be produced. In this respect, the particularly precise positioning of the sheet by pressing on the press frame and, optionally, an unchanged position of the press frame when a sheet is resting thereon is very advantageous.

A means for fixing a sheet on the respective contact surface is associated with each mold. The means for fixing a sheet on the contact surface preferably comprises a pneumatic suction device for sucking in a gaseous fluid, in particular, air, by which the sheet can be pulled against the contact surface by means of negative pressure. The contact surface can be provided, for this purpose, for example, with at least one suction hole, advantageously with a plurality of suction holes uniformly distributed, for example, over the contact surface, on which a negative pressure can be applied to the contact surface in each case for a suction effect. The suction device can, alternatively or additionally, have an apron surrounding the contact surface, by means of which a negative pressure can be produced on the contact surface. The suction device generates a typically upward directed flow of a gaseous fluid, in particular air, which suffices to firmly hold the sheet against the contact surface.

Preferably, a means for removing a sheet fixed on the respective contact surface is associated with the molds in each case. This is advantageously a pneumatic blowing device for ejecting a gaseous fluid, in particular, air, by means of which the sheet can be removed from the contact surface by means of positive pressure. The contact surface can be provided, for this purpose, for example, with at least one blow hole, advantageously with a plurality of blow holes uniformly distributed over the contact surface, for example. The blowing device generates a typically downward directed stream of a gaseous fluid, in particular, air, by which the sheet can be removed from the contact surface. This enables reliable placing of the sheet on a frame without the risk of the sheet undesirably adhering to the contact surface. The suction and blowing device associated in each case with the molds can be combined to form one suction/blowing device wherein holes on the contact surface can be selectively subjected to negative or positive pressure. If a heatable mold carrier module cavity is provided to receive the transportable mold, it can be advantageous for the means of generating a negative or positive pressure of the suction and/or blowing device that is associated with the transportable mold to be arranged outside the heatable mold carrier module cavity.

Preferably, the device for bending sheets further includes a pneumatic blowing device for generating a gaseous fluid flow, in particular, an air flow, that is implemented such that a sheet can be blown from below, lifted thereby, and pressed against the contact surface of a mold. The blowing device can, in particular, be designed such that the sheet fixed against the contact surface can be pre-bent in the edge region and/or in the inner region by the pressure exerted by the gaseous flow of fluid, advantageously at least in the edge region.

According to one embodiment, the device according to the invention for bending sheets has a thermal tempering zone with a cooling device for thermal tempering of a sheet, as well as a tempering frame (e.g., tempering ring) for transporting a sheet from the bending chamber to the tempering zone. Preferably, the tempering frame is movable with at least one horizontal movement component. Advantageously, the tempering frame is movable reciprocally and translationally in a horizontal plane (one dimensionally). The thermal tempering deliberately creates a temperature differential between a surface zone and the core zone of the sheet to increase the breaking strength of the sheet. The tempering of the sheet is advantageously produced by means of a device for blowing on the sheet with a gaseous fluid, preferably air. Preferably, both surfaces of a sheet are simultaneously subjected to a cooling air flow. The tempering frame is coupled with a tempering frame movement mechanism by which the tempering frame can be moved reciprocally. The tempering frame movement mechanism is preferably not coupled with a movement mechanism for the press frame.

A single sheet can be transported in each case on the press frame and the tempering frame. It goes without saying that one sheet can be on the press frame and another sheet, on the tempering frame at the same time. Advantageously, the tempering frame for transporting a sheet from the bending chamber to the tempering zone has a frame surface suitably designed for the edge final bending in the edge region of the sheet. In addition, it is advantageous for the tempering frame to be suitably designed for surface final bending by gravity in the inner region of the sheet. Edge final bending and surface final bending by gravity can be done during the transport of a sheet on the tempering frame.

According to one embodiment, the device according to the invention for bending sheets has a preheating zone with a heating device for heating sheets to a bending temperature (softening temperature of glass), as well as a transport mechanism, in particular of the roller bed type, for transporting sheets from the preheating zone to the bending chamber, in particular to a removal position, which is situated directly below the stationary mold vertically. Accordingly, sheets can be transported into the bending chamber on the roller bed, preferably to a removal position directly below stationary mold. The roller bed is advantageously implemented such that individual sheets can be transported one after another to the removal position. The removal position can, in particular, correspond to an end section of the roller bed. Typically, the sheets are heated from a temperature below a softening temperature of the glass to the softening temperature or bending temperature in the preheating zone, typically with the temperature of the sheets merely maintained in the bending chamber, i.e., typically, no further temperature increase of the sheets occurs in the bending chamber. Typically, the sheets arrive in the bending chamber already at a temperature suitable for bending.

According to one embodiment, the device according to the invention for bending sheets has a further module, referred as the “press frame module” to for easier reference and differentiation from the above-mentioned mold carrier module. The press frame module forms a structural unit and is preferably, but not mandatorily, movable relative to the bending chamber such that the press frame module can be delivered to the bending chamber or removed from the bending chamber. For this purpose, the press frame module preferably has an actively or passively drivable movement mechanism for moving the press frame module relative to the bending chamber, for example, a roller transport mechanism or an air cushion transport mechanism. Preferably, the press frame module has a cavity, referred to in the following as the “press frame module cavity”, which is completely delimited by a preferably insulated wall. The wall separates the press frame module cavity from the external environment.

The press frame module has a movable press frame carrier with a preferably immovably mounted press frame for storage and pressing a sheet lying thereon. Preferably, the press frame is arranged in the press frame module cavity or can be arranged (completely) in the press frame module cavity. The press frame carrier is movable relative to the bending chamber. The press frame module is delivered or can be delivered to the bending chamber such that the press frame carrier can be introduced together with the press frame (from a position outside the bending chamber) into the bending chamber. The press frame module cavity has at least one first opening, which can be brought into a position opposite a second opening of the bending chamber cavity of the bending chamber such that a preferably aligned connection of the press frame module cavity and the bending chamber cavity can be established. Preferably, the first opening of the press frame module cavity and/or the second opening of the bending chamber cavity are provided in this case with a door by which the associated opening can be closed. The spatial connectivity of the press frame module cavity and the bending chamber cavity is essential, in particular by opening at least one door between the press frame module cavity and the bending chamber cavity.

The press frame is advantageously movable reciprocally and translationally in a horizontal plane (i.e., one dimensionally). For its movement, the press frame carrier is coupled with a movement mechanism. To meet very high quality requirements for the sheets produced, very precise positioning of the press frame is necessary, typically requiring precision of less than 1 mm, typically at least approx. 0.5 mm. In order to avoid errors due to thermal expansion in the hot bending chamber, a movement mechanism for the press frame carrier is advantageously arranged outside the bending chamber in a non-heated region of the press frame module. In addition, this enables particularly fast positioning of the press frame carrier, which is another significant advantage since it reduces cycle times.

The press frame module is a self-contained structural unit that enables the press frame module to be fitted with the press frame independently of the bending chamber. In particular, the movability of the press frame carrier to the outside enables easy and fast loading of the press frame module. If the press frame module is movable, the press frame module can be delivered to the bending chamber and removed again. This provides, in particular, free access to the bending chamber for maintenance work or adjustments for a specific bending operation.

According to one embodiment of the device according to the invention for bending sheets, the device is implemented such that the sheets are fed into the bending chamber from a first direction and the at least one transportable mold is introduced into the bending chamber from a second direction different from the first direction. For example, a first direction in which the sheets are fed into the bending chamber is arranged at an angle of 90° relative to a second direction in which the at least one transportable mold (without a sheet fixed thereon) is introduced into the bending chamber. In any case, the direction in which sheets are transported into the bending chamber and the direction in which the transportable mold is introduced into the bending chamber are not the same.

In the following, there is a description of the method according to the invention for bending sheets, for which independent protection is claimed. The above described device according to the invention for bending sheets is preferably used to carrying out the method according to the invention such that statements made above concerning the device according to the invention apply analogously to the method according to the invention. Features that are indicated for the device according to the invention apply in the same way to the method according to the invention.

In the method for bending sheets according to the invention, in a bending chamber, a sheet is fixed on the contact surface of a transportable mold and placed onto a frame by the mold. It is essential here that the transportable mold be introduced into the bending chamber before the fixing of the sheet on the transportable mold in the bending chamber with the sheet not fixed on the transportable mold at time of introduction of the transportable mold into the bending chamber and that it be removed again from the bending chamber after the placement of the sheet on the frame without a fixed sheet.

The transportable mold is thus not used for transporting a sheet into the bending chamber or out of the bending chamber. Fixing of a sheet on the transportable mold is done exclusively within the bending chamber. Preferably, movement of the transportable mold into the bending chamber and out of the bending chamber is exclusively horizontal. Preferably, movement of the transportable mold within the bending chamber with a sheet fixed on the transportable mold is exclusively vertical.

Accordingly, between the fixing of a (first) sheet on the transportable mold within the bending chamber and the immediately following fixing of another (second) sheet on the transportable mold within the bending chamber, the transportable mold is introduced into the bending chamber and removed from the bending chamber without a sheet fixed thereon.

According to one embodiment of the method, the sheets are fed into the bending chamber from a first direction, and the at least one transportable mold is introduced into the bending chamber from a second direction different from the first direction. Preferably, the sheets are provided in the bending chamber by a roller bed.

According to a preferred embodiment, the method for bending sheets comprises the steps listed below, which are advantageously, but not mandatorily, carried out in the order indicated. In particular, a step can also be carried out after a step mentioned later in the following list provided this is possible and reasonable in terms of the method.

The method includes a step in which a sheet, preferably heated to bending temperature, is provided in the bending chamber. Advantageously, the sheet is, for this purpose, moved with at least one horizontal movement component, in particular, in a horizontal plane. Preferably, the sheet is transported into the bending chamber on a roller bed.

The method includes another step, in which the sheet is fixed on a contact surface of a first mold. Advantageously, fixing the sheet on the contact surface is done in that the sheet is lifted by blowing on it with a gaseous fluid and pressed against the contact surface. Alternatively, and preferably additionally, the sheet is fixed on the contact surface by suction. For example, but not mandatorily, the sheet is subjected on the contact surface of the first mold to edge pre-bending in the edge region and/or to surface pre-bending in the inner region of the sheet. Preferably, the first mold is lowered for this purpose onto the sheet, for example, by moving vertically, and is raised again after fixing the sheet on the contact surface, for example, by moving vertically.

The method includes another step, in which a press frame for the sheet is positioned within the bending chamber, preferably while the sheet is fixed on the contact surface of the first mold. Preferably, the press frame is introduced into the bending chamber from outside the bending chamber. Advantageously, the press frame is moved for this purpose with a horizontal movement component, in particular in a horizontal plane.

The method includes another step, in which the sheet is placed on the press frame. During the storage on the press frame, a (passive) surface pre-bending preferably occurs due to the sheet's own weight in an inner region of the sheet surrounded by the edge region. The placing of the sheet on the press frame is advantageously assisted by blowing with a gaseous fluid.

Optionally, the method can include another step, in which the sheet is pressed between the contact surface of the first mold and the press frame (first pressing of the sheet) before placement on the press frame. Here, edge pre-bending or edge final bending occurs in an edge region of the sheet. Preferably, for this, the first mold with the sheet fixed on the contact surface is lowered onto the stationary press frame, for example, vertically, such that the sheet fixed on the contact surface makes contact with the press frame. In order to then place the sheet on the press frame, it suffices to release the fixing connection between the contact surface of the first mold and the sheet and to remove the first mold from the press frame. The sheet is already in contact with the press frame during pressing. Undesirable adhesion to the contact surface can be avoided by blowing with a gaseous fluid.

The method includes another step, in which the sheet resting on the press frame is pressed between a second mold and the press frame (second pressing of the sheet), wherein edge pre-bending or edge final bending occurs in the edge region of the sheet. Advantageously, for this, the second mold is lowered onto the sheet resting on the stationary press frame, for example, vertically, such that the contact surface of the second mold makes contact with the sheet.

The method includes another step, in which the sheet is fixed on the contact surface of the second mold after the second pressing between the contact surface of the second mold and the press frame. Here, for example, surface pre-bending or surface final bending can occur in the inner region; and edge pre-bending or edge final bending, in the edge region of the sheet. Advantageously, the sheet is fixed by suction on the contact surface of the second mold. Preferably, the second mold with the sheet fixed on the contact surface is removed from the press frame. Advantageously, the press frame is removed from the bending chamber as soon as the sheet is fixed on the contact surface of the second mold (i.e., no longer rests on the press frame) and the second mold is removed from the press frame.

The method includes another step, in which a tempering frame is positioned in the bending chamber. Preferably, the tempering frame is moved translationally (one dimensionally) in a horizontal plane.

The method includes another step, in which the sheet is placed on the tempering frame by the second mold. Advantageously, for this purpose, the second mold with the sheet fixed on the contact surface is lowered onto the tempering frame, for example, vertically.

The method includes another step, in which the sheet is transported on the tempering frame to a cooling device for thermal tempering of the sheet. Advantageously, for this purpose, the tempering frame is moved with a horizontal movement component, in particular in a horizontal plane. Preferably, the tempering frame is moved translationally (one dimensionally).

It is essential in the method described above that either the first mold is a transportable mold and the second mold is a stationary mold or, alternatively, the second mold is a transportable mold and the first mold is a stationary mold in the context of the invention. Particularly advantageously, the transportable mold is fastened on a mold carrier that can be introduced into the bending chamber by a mold carrier module and is introduced into the bending chamber and removed from the bending chamber by moving the mold carrier. Particularly advantageously, before introduction into the bending chamber, the transportable mold is heated (to a temperature suitable for bending sheets, in particular, to a temperature that prevails in the bending chamber).

Accordingly, according to the first alternative, the first mold (without a sheet fixed on the first mold) is introduced from outside the bending chamber into the bending chamber before the fixing of the sheet on its contact surface and removed from the bending chamber after the placing of the sheet on the press frame (without a sheet fixed on the first mold). The second mold is permanently arranged in the bending chamber at least during a period of time from when the sheet is provided in the bending chamber until the sheet is transported on the tempering frame. According to the second alternative, after placement of the sheet on the press frame, the second mold (without a sheet fixed on the second mold) is inserted into the bending chamber from outside the bending chamber and is removed (without a sheet fixed on the second mold) from the bending chamber after placement of the sheet on the tempering frame. The first mold is permanently arranged in the bending chamber at least during a period of time from when the sheet is provided in the bending chamber until the sheet is transported on the tempering frame.

In an advantageous embodiment of the method according to the invention, the press frame is introduced into the bending chamber (from a position outside the bending chamber) before the sheet is placed on the press frame and removed from the bending chamber after the sheet is fixed on the contact surface of the second mold. Particularly advantageously, the press frame is fastened on a press frame carrier that can be introduced into the bending chamber by a press frame module and is introduced into the bending chamber and removed from the bending chamber by moving the press frame carrier. Preferably, the press frame and/or the press frame carrier can be supported downward when a sheet can rest thereon.

In an advantageous embodiment of the invention, the press frame is not moved with a sheet resting thereon. As a result, particularly high quality requirements for the sheet can be met since there is no risk of the position of the sheet relative to the press frame changing undesirably due to a movement of the press frame. In particular, by pressing the sheet on the press frame, the sheet can be positioned very precisely relative to the press frame.

Particularly advantageously, while it is fixed on a mold, the sheet has no movement with a horizontal movement component, i.e., it is moved only vertically. This further improves the precise positioning of the sheet. The press frame and the transportable mold can be very precisely positioned in the bending chamber, in particular when the movement mechanism for moving the press frame carrier and/or the movement mechanism for moving the mold carrier is in each case arranged outside the heated region of the associated module.

In an advantageous embodiment of the method according to the invention, passive edge pre-bending occurs by the sheet's own weight or active edge pre-bending occurs by pressing in the edge region of the sheet by placing the sheet on the press frame and, optionally, by pressing the sheet between the first mold and the press frame. Then, as a result of the (optional second) pressing of the sheet between the second mold and the press frame, further edge pre-bending occurs in the edge region of the sheet. And finally, edge final bending occurs in the edge region of the sheet during transport of the sheet on the tempering frame.

In an advantageous embodiment of the method according to the invention, passive edge pre-bending occurs by the sheet's own weight or active edge pre-bending occurs by pressing in the edge region of the sheet by sheet placing the sheet on the press frame and, optionally, by pressing the sheet between the first mold and the press frame. Then, as a result of the (optional second) pressing of the sheet between the second mold and the press frame, edge final bending occurs in the edge region of the sheet.

In another advantageous embodiment of the method according to the invention, (active) edge final bending in the edge region of the sheet is done by pressing the sheet between the first mold and the press frame.

According to an advantageous embodiment of the method according to the invention, during storage of the sheet on the press frame, (passive) surface pre-bending occurs in an inner region of the sheet surrounded by an edge region by gravity or by the sheet's own weight.

The bending of the sheet by means of the second mold can give the sheet a final or quasi-final shape. Typically, but not mandatorily, the shape of the sheet will still change (usually slightly) on the tempering frame, for which purpose the tempering frame preferably has a frame surface that is suitably designed for edge final bending. In addition, the tempering frame is suitably designed for surface final bending by gravitation. The sheet thus receives its final shape on the tempering frame. Accordingly, according to another advantageous embodiment of the method according to the invention, during transport or resting storage of the sheet on the tempering frame, surface final bending occurs by gravity in an inner region of the sheet surrounded by an edge region.

In the method according to the invention and the device for carrying it out, there is at no time a situation wherein the stationary mold, the transportable mold, the press frame, and the tempering frame are arranged in a position above or below one another.

The invention further extends to the use of the device according to the invention as well as the method according to the invention for producing panes for means of transportation for travel on land, in the air, or on water, in particular in motor vehicles, and in particular for rear windows in motor vehicles.

The various embodiments of the invention can be realized individually or in any combinations. In particular, the features mentioned above and to be explained in the following can be used not only in the combinations indicated, but also in other combinations or in isolation, without departing from the scope of the present invention.

The invention is explained in detail using exemplary embodiments and referring to the accompanying figures. They depict, in simplified, not-to-scale representation:

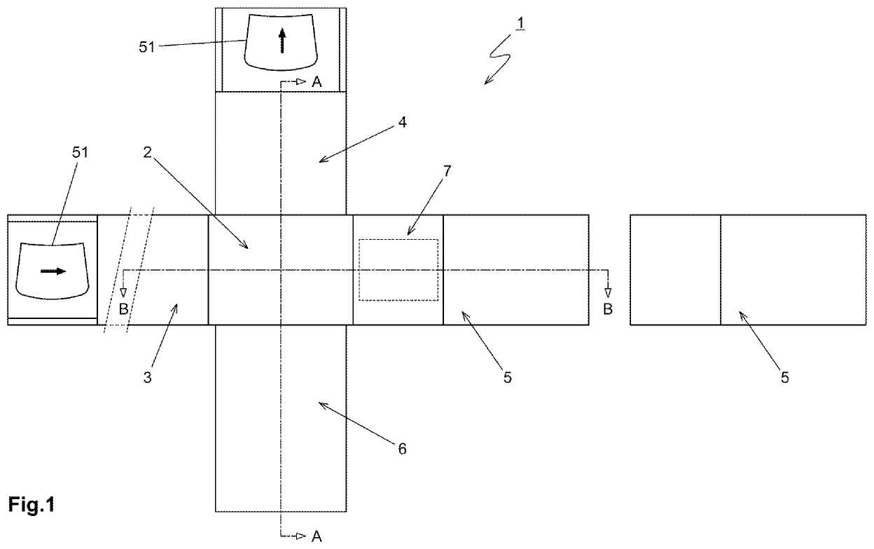

FIG. 1 a schematic representation of an exemplary embodiment of the device according to the invention for bending sheets in plan view;

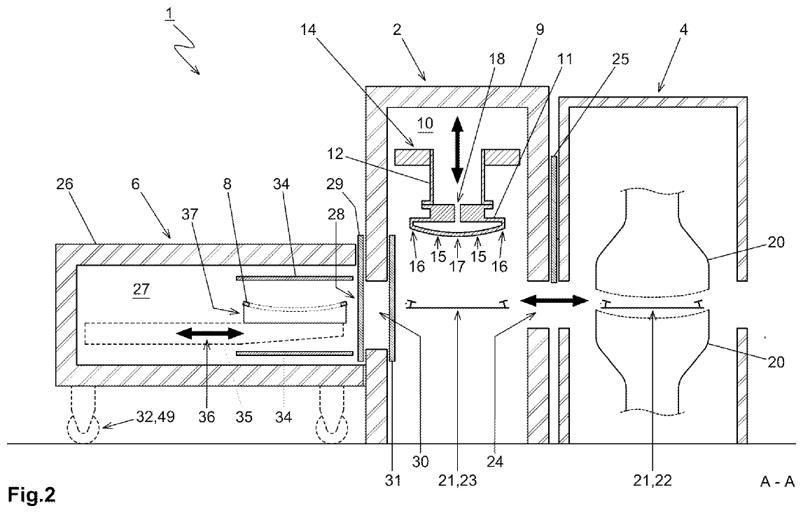

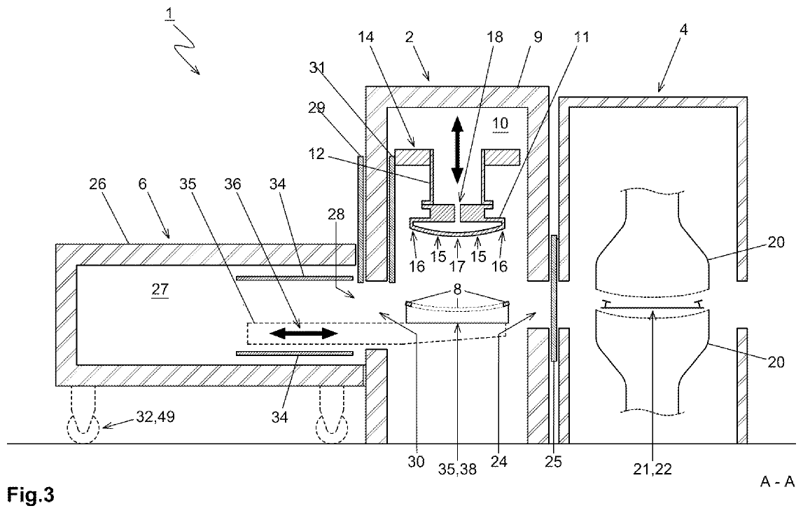

FIG. 2-3 various sectional views of the device of FIG. 1 along section plane A-A;

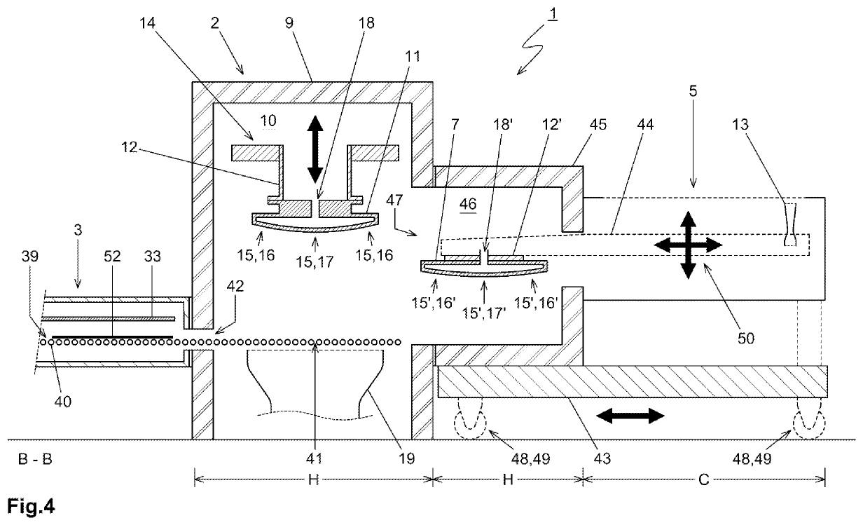

FIG. 4 a sectional view of the device of FIG. 1 along section plane B-B;

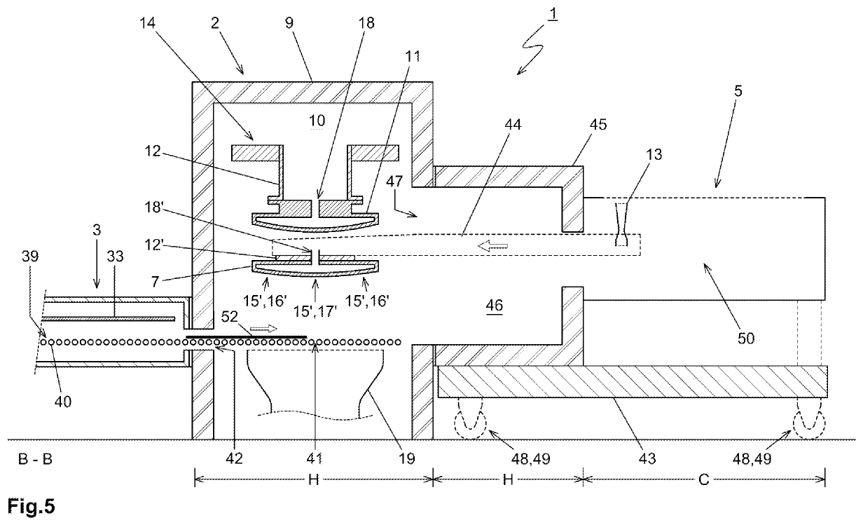

FIG. 5-20 various sectional views of the device of FIG. 1 along section plane B-B to illustrate the method according to the invention;

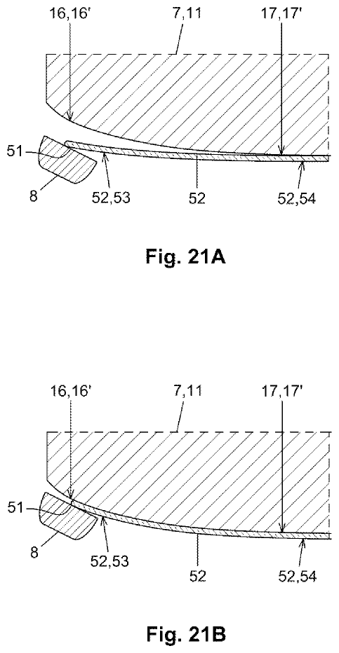

FIG. 21A-21B schematic representations to illustrate the pressing of a sheet between a mold and the press frame;

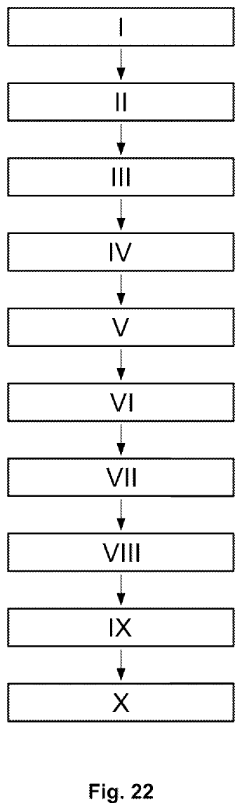

FIG. 22 a flow chart of an exemplary embodiment of the method according to the invention for producing a sheet.

Considering first, FIGS. 1 to 4. FIG. 1 depicts, based on a schematic representation in plan view, essential components of an exemplary embodiment of the device for bending sheets designated as a whole with reference number 1. FIGS. 2 and 3 depict a sectional representation of the device 1 along section plane A-A; FIG. 4 depicts a sectional representation along section plane B-B.

As depicted in FIG. 1, the device 1 comprises a bending chamber 2 for bending (glass) sheets 52, a preheating zone 3 arranged to the side of the bending chamber 2 with a (preheating zone) heating device 33 (not shown in FIG. 1) for heating the sheets to bending temperature, and a tempering zone 4 also arranged to the side of the bending chamber 2 for cooling or tempering bent sheets. The preheating zone 3 and the tempering zone 4 are arranged, viewed from above, at an angle of 90° on the bending chamber 2 and are functionally coupled therewith, with the preheating zone 3 and the tempering zone 4 designed as spatially separate regions of the device 1.

Arranged on the bending chamber 2 opposite the preheating zone 3 is a modular delivery chamber for a transportable mold 7, referred to in the following as “mold carrier module 5”. Arranged on the bending chamber 2 opposite the tempering zone 4 is a modular delivery chamber for a press frame 8 (not shown in FIG. 1), referred to in the following as “press frame module 6”. The preheating zone 3, the tempering zone 4, the mold carrier module 5, and the press frame module 6 are arranged on four sides of the bending chamber 2 and functionally coupled with the bending chamber 2.

FIG. 1 depicts the mold carrier module 5 in two spatially different positions. In a first position, the mold carrier module 5 is arranged on the bending chamber 2 and functionally coupled therewith. In a second position (to the right of the first position in FIG. 1), the mold carrier module 5 is spatially separated from the bending chamber 2 and not functionally coupled with the bending chamber 2. Similarly to the mold carrier module 5, the press frame module 6 can be brought into a position spatially separated from the bending chamber 2 (not shown in FIG. 1).

FIG. 2 (section plane A-A of FIG. 1) depicts in more detail the bending chamber 2, the press frame module 6, and the tempering zone 4, which are arranged opposite one another on the bending chamber 2. Accordingly, the bending chamber 2 comprises an insulating bending chamber wall 9, which delimits a cavity of the bending chamber 2, referred to in the following as bending chamber cavity 10, from the external environment. Thus, the bending chamber cavity 10 can be heated to and maintained at a temperature (bending temperature) suitable for the bending operation of the sheets. For heating the bending chamber cavity 10, the bending chamber 2 has a heating device (not shown). Situated in the bending chamber cavity 10 is a stationary mold 11, which remains permanently within the bending chamber 2 for processing sheets, i.e., is not introduced into the bending chamber 2 and/or removed from the bending chamber 2 during the period of time while one and the same sheet is processed in the device 1.

The stationary mold 11 has a holder 12 which can be displaced at least vertically relative to the bending chamber wall 9 by a holder movement mechanism 14 (not shown in detail). It is also possible for the holder 12 to be displaced with at least one horizontal movement component. The stationary mold 11 is detachably mounted at the lower end of the holder 12. The stationary mold 11 has a downward directed, convex contact surface 15 for the areal contact of a sheet 52. With appropriate contact pressure, the sheet 52 can be bent on the respective contact surface 15. The contact surface 15 has an end or edge outer surface section 16 and an inner surface section 17 with surface contours (surface shapes) different from one another, with the inner surface section 17 being completely surrounded (bordered) by the outer surface section 16.

The stationary mold 11 includes a combined suction/blowing device 18 (not shown in detail) for sucking a sheet 52 against the contact surface 15 or removing a sheet 52 fixed on the contact surface 15. For this, the contact surface 15 can, for example, be provided with evenly distributed holes (not shown) and/or an apron at the edge. A sheet 52 can be drawn against the contact surface 15 by a negative pressure generated in the holes or the edge apron. In a corresponding manner, the sheet 52 can be removed from the contact surface 15 when a positive pressure is generated in the holes.

The bending chamber 2 also has a blowing device 19 (not shown in detail), by which a flowing gaseous fluid, e.g., an air flow 55, can be generated vertically in order to lift a sheet 52 against gravity and, in particular, to press it against the contact surface 15 of the (lowered) stationary mold 11.

Situated to the side of the bending chamber 2 is the tempering zone 4 for tempering bent sheets. The tempering zone 4 has two so-called “tempering boxes” 20, arranged offset from one another vertically. By means of the two tempering boxes 20, an air flow for the air cooling of a sheet 52 situated between the two tempering boxes 20 can be generated in order to temper the sheet 52.

For the resting transport of a sheet 52 from the bending chamber 2 into the tempering zone 4, a tempering frame 21 is provided, which is situated below the stationary mold 11 in FIG. 2. The tempering frame 21 can be moved by a tempering frame movement mechanism (not shown in detail) between the bending chamber 2 and the tempering zone 4 (e.g., in a horizontal plane). Preferably, the tempering frame 21 can be moved back and forth translationally in a horizontal plane between a first tempering frame position 22 situated between the two tempering boxes 20 and a second tempering frame position 23 within the bending chamber 2 situated, for example, directly below the stationary mold 11.

In order to couple the tempering zone 4 to the bending chamber 2, the bending chamber wall 9 has a first bending chamber opening 24, which opens into the bending chamber cavity 10. The first bending chamber opening 24 can be closed by a first bending chamber door 25 such that the bending chamber cavity 10 can be open to the outside or closed against the external environment. The tempering frame 21 can be moved through the opened first bending chamber opening 24 into the bending chamber cavity 10 in order to receive a finished bent sheet 52 and to transport it into the tempering zone 4. From there, the tempered sheet 52 can be removed easily and further processed.

The device 1 further includes a movable (mobile) press frame module 6, which is arranged opposite the tempering zone 4 on the outside of the bending chamber 2. Like the bending chamber 2, the press frame module 6 is designed here, for example, in the form of a closed or closable chamber. The press frame module 6 includes an insulating press frame module wall 26, which delimits a cavity of the press frame module 6, referred to in the following as “press frame module cavity 27”, from the external environment. The press frame module cavity 27 is accessible from the outside through at least one press frame module opening 28 that opens into the press frame module cavity 27. The press frame module opening 28 can be closed by a press frame module door 29.

As depicted in FIG. 2, the press frame module 6 is arranged outside the bending chamber 2, with the press frame module opening 28 in a position opposite a second bending chamber opening 30 of the bending chamber cavity 10. The bending chamber cavity 10 is accessible from the outside through the second bending chamber opening 30 that opens into the bending chamber cavity 10. The second bending chamber opening 30 can be closed by a second bending chamber door 31. When the press frame module 6 is arranged on the bending chamber 2, the bending chamber cavity 10 and the press frame module cavity 27 can be spatially connected to one another by opening both the press frame module door 29 and the second bending chamber door 31. On the other hand, the press frame module cavity 27 can be spatially separated from the bending chamber cavity 10 by closing the press frame module door 29 and/or the second bending chamber door 31.

The press frame module 6 is movable relative to the bending chamber 2 and has, for this purpose, an actively or passively drivable press frame module movement mechanism 32 for moving the press frame module 6 (for example, roller bearings). By means of the press frame module movement mechanism 32, the press frame module 6 can be delivered to the bending chamber 2 or removed from the bending chamber 2.

The press frame module cavity 27 is surrounded by an insulating press frame module wall 26. As a result, the press frame module cavity 27 can be heated to and maintained at a desired temperature. For example, the press frame module cavity 27, like the bending chamber 2, is heated to a temperature (bending temperature) suitable for the bending operation of the sheets 52. For heating the press frame module cavity 27, the press frame module 6 has a press frame module heating device 34, which is implemented in the form of radiant heaters in the embodiment of FIG. 2. The radiant heaters are, for example, distributed in a plurality of radiant heater arrays.

The press frame module 6 also has an elongated press frame carrier 35 for the press frame 8. The press frame carrier 35 is movable by a press frame carrier movement mechanism 36. The press frame carrier movement mechanism 36 is arranged outside the heatable press frame module cavity 27 (below the press frame module cavity 27 in FIG. 2). In the exemplary embodiment depicted, the press frame carrier movement mechanism 36 includes a pinion chain mechanism equipped with a driven pinion, which is known to the person skilled in the art and does not need to be explained in detail. In the situation depicted in FIG. 2, the press frame carrier 35 is situated completely within the press frame module cavity 27. The press frame module door 29 and the second bending chamber door 31 are in a closed position in each case. The press frame 8, which is used to press and store a sheet 63 [sic], is fixedly attached to the free end of the press frame carrier 35. For this purpose, the press frame carrier 35 comprises, for example, two parallel carrier arms, between which the press frame 8 is fastened.

In the device 1 according to the invention, a movement of the press frame 8 within the bending chamber 2 is done by the press frame carrier 35 supplied from outside the bending chamber 2, wherein due to the fact that the press frame carrier movement mechanism 36 is arranged outside the heatable press frame module cavity 27, very precise positioning of the press frame 8 is made possible in a particularly advantageous manner.

Reference is now made to FIG. 3, wherein the device 1 is depicted according to the sectional view A-A of FIG. 2 in a different situation of the method. In order to avoid unnecessary repetition, only the differences relative to FIG. 2 are explained; and, otherwise, reference is made to the above statements. In the situation of FIG. 3, the tempering frame 21 is situated in the first tempering frame position 22 between the two tempering boxes 20. The press frame 8 was transported within the bending chamber 2 by moving the press frame carrier 35 from a press frame resting position 37 into a press frame working position 38. The free end of the press frame carrier 35 carrying the press frame 8 was introduced, for this purpose, into the bending chamber cavity 10 (a part of the press frame carrier 35 is still situated in the press frame module 6). As a result of heating the press frame module cavity 27 by means of the the press frame module heating device 34, the press frame 8 can also be heated quickly outside the bending chamber cavity 10 to a temperature suitable for bending sheets 52. Particularly advantageously, the bending chamber cavity 10 can be closed by closing the bending chamber doors 25, 31, for example, in order to remove the press frame module 5 from the bending chamber 2, without the bending chamber cavity 10 being exposed to the external environment, whereby, in particular, a greater temperature drop in the bending chamber cavity 10 can be avoided. Accordingly, another module can be coupled with the bending chamber 2 in a simple manner.

Reference is now made to FIG. 4, wherein a part of the device 1 of FIG. 1 according to the sectional plane B-B (perpendicular to the sectional plane A-A) is depicted. FIG. 4 depicts the bending chamber 2, the mold carrier module 5 arranged on the bending chamber 2 and functionally coupled therewith, as well as a part of the preheating zone 3. As already described in connection with FIG. 2, the bending chamber 2 includes the bending chamber cavity 10, in which the stationary mold 11 is arranged. The stationary mold 11 has a contact surface 15 with an outer surface section 16 and an inner surface section 17.

Arranged on the bending chamber 2 and functionally coupled therewith is the preheating zone 3, in which sheets 52 can be heated to a temperature suitable for bending. In the device 1, sheets can be successively transported from the preheating zone 3 into the bending chamber 2 and, finally, into the tempering zone 4. For transport of the sheets from the preheating zone 3 into the bending chamber 2, for example, a roller bed with a plurality of cylindrical rollers is provided for the areal support of sheets 52.

Still referring to FIG. 4, the movable (mobile) mold carrier module 5, which is arranged opposite the preheating zone 3 on the outside of the bending chamber 2, is described. The mold carrier module 5 includes a substructure 43, on which a mold carrier 44 is attached. A mold 7 is fixedly attached at the end of the mold carrier 44, which mold 7 becomes a transportable mold due to the movability of the mold carrier 44. The mold carrier 44 opens into a mold carrier module cavity 46 surrounded by a mold carrier module wall 45 and open to the bending chamber 2, in which the transportable mold 7 is arranged. The bending chamber wall 9 has, on the side to which the mold carrier module 5 can be delivered, a fourth bending chamber opening 47. When the mold carrier module 5 is delivered to the bending chamber 2, the mold carrier module cavity 46 opens into the bending chamber cavity 10. The mold carrier module wall 45 makes physical contact with the outside of the bending chamber wall 9. Not shown in FIG. 4, but possible, would be providing the fourth bending chamber opening 47 and/or the mold carrier module cavity 46 in each case with a door for separate closing.

The mold carrier module cavity 46 can be heated to a desired temperature. For example, the mold carrier module cavity 46, like the bending chamber 2, is heated to and maintained at a temperature (bending temperature) suitable for a bending operation of the sheets 52, in order to heat the transportable mold 7 to such a temperature. The mold carrier module cavity 46 has, for this purpose, a heating device (e.g., radiant heater) designed in the form of radiant heaters (not shown in FIG. 4). The hot and cold regions are identified in FIG. 4 by “H(ot)” and “C(old)”.

The mold carrier module 5 is movable relative to the bending chamber 2 and has, for this purpose, an actively driven or passively drivable mold carrier module movement mechanism 50 for moving the mold carrier module 5. In the present exemplary embodiment, the mold carrier module movement mechanism 50 includes a plurality of passively drivable wheels 49. By means of the mold carrier module movement mechanism 50, the mold carrier module 5 can be delivered to the bending chamber 2 or removed from the bending chamber 2.

The mold carrier module 5 has the elongated mold carrier 44 for the transportable mold 7. The mold carrier 44 is movable vertically by a mold carrier movement mechanism 48 and with a horizontal movement component such that the mold 7 attached on the mold carrier 44 can be introduced into the bending chamber 2 for the processing of a respective sheet 52 and removed again therefrom. The mold carrier movement mechanism 50 is arranged outside the heatable mold carrier module cavity 46 such that, in a particularly advantageous manner, very precise positioning of the transportable mold 7 within the bending chamber 2 is made possible.

The transportable mold 7 can be moved by moving the mold carrier 44 within the bending chamber 2 with a horizontal movement component and vertically (one dimensionally and reciprocally in each case). The transportable mold 7 has a downward directed contact surface 15′, which is composed of an outer surface section 16′ and an inner surface section 17′.

The contact surfaces 15, 15′ of the molds 11, 7 can have the same or different surface contours. Preferably, the surface contours are different from one another. For example, the outer surface section 16′ of the contact surface 15′ of the transportable mold 7 has a surface contour that is adapted to a desired edge final bending, i.e., final bending, in a (for example, strip-shaped) edge region 53 of the sheet 52 or enables such final bending in the further processing of the sheet 52. The end edge region of the sheet 52 is adjacent a sheet (cut) edge arranged perpendicular to the two opposing primary surfaces of the sheet. The inner surface section 17′ of the contact surface 15′ of the transportable mold 7 has a surface contour that corresponds to a surface pre-bending, i.e., non-final bending in an inner region 54 of the sheet 52 completely surrounded by the edge region. The outer surface section 16 of the contact surface 15 of the stationary mold 11 has the same surface contour as the outer surface section 16′ of the contact surface 15′ of the transportable mold 7 and has a surface contour that is adapted to the desired edge final bending in the edge region 53 of the sheet 52. In contrast to the inner surface section 17′ of the contact surface 15′ of the transportable mold 7, the inner surface section 17 of the contact surface 15 of the stationary mold 11 has a surface contour that is adapted to a surface final bending, i.e., a final or quasi-final bending, in the inner region 54 of the sheet 52 or makes this possible in the further processing.

The transportable mold 7 further has a combined suction/blowing device 18′ (not shown in detail) for sheets, by means of which a sheet 52 can be sucked against the contact surface 15′ and thus temporarily fixed on the contact surface 15′ or removed from the contact surface 15′. A negative or positive pressure on the contact surface 15′ can be generated based on the Venturi principle by a Venturi device 13 that is situated in the cold region of the mold carrier module 5.

In the device 1, the press frame 8 is used for storage and pressing of sheets in cooperation with a mold. For this purpose, the press frame 8 has an edge (e.g., strip-shaped) press surface 51 (see FIGS. 21A and 21B), whose surface contour is, for example, complementary to the surface contour of the outer surface sections 16, 16′ of the stationary mold 11 and the transportable mold 7. The upward facing press surface 51 is suitable for pressing a sheet 52 resting thereon in an edge region 53. The press frame 8 is not designed as a full surface, but, instead, has an internal opening that allows surface pre-bending of the inner region 54 of a sheet 52 placed thereon by gravity.

Supplementing FIG. 4, reference is now made to FIGS. 5 to 20, which depict sectional views of the device 1 analogous to FIG. 4, in order to describe an exemplary embodiment of the method according to the invention. In order to avoid unnecessary repetition, in each case only the differences of the method situations depicted are described; otherwise, reference is made to the statements above.

FIG. 4 depicts a starting situation in which the transportable mold 7 is situated within the mold carrier module cavity 46 and has been heated to a temperature suitable for the processing of sheets. For this purpose, the bending chamber cavity 10 and the mold carrier module cavity 46 are heated to one and the same temperature. The transportable mold 7 can, in particular, be arranged completely within the mold carrier module cavity 46. The stationary mold 11 is situated within the bending chamber 2. A sheet 52, which is heated to a temperature suitable for bending, is situated in the preheating zone 3 (not shown).

FIG. 5 depicts the device 1 for bending sheets at a later time than in FIG. 4. The sheet 52 is situated in a removal position. The mold carrier 44 is moved horizontally into the bending chamber 2, with the transportable mold 7 situated in a position vertically elevated directly above the sheet 52. The stationary mold 11 is also situated in the bending chamber 2 and is arranged above and/or to the side of the transportable mold 7. Preferably, the stationary mold 11 is moved far enough upward in the bending chamber 2 that there is space for the transportable mold 7 vertically directly below the stationary mold 11.

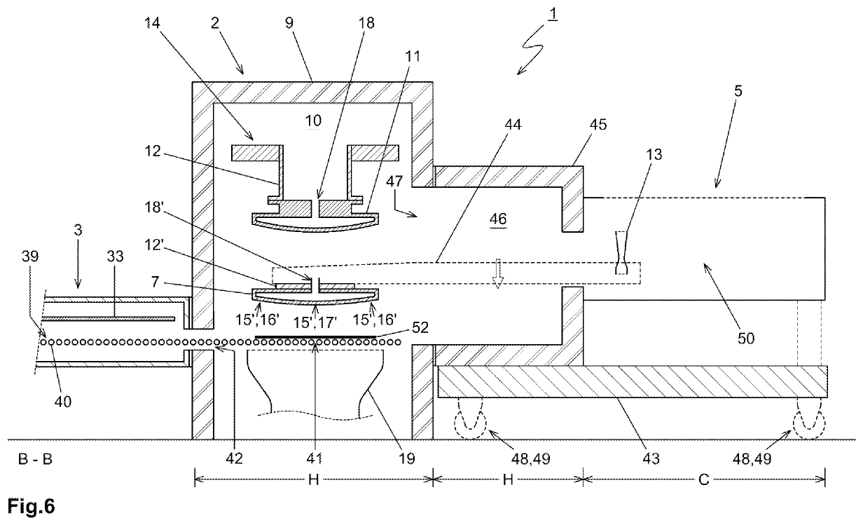

FIG. 6 depicts the device 1 for bending sheets at a later time than in FIG. 5. The mold carrier 44 with the transportable mold 7 situated thereon has been lowered vertically such that the transportable mold 7 is now situated just above the sheet 52. There has been no change in the position of the transportable mold 7 horizontally.

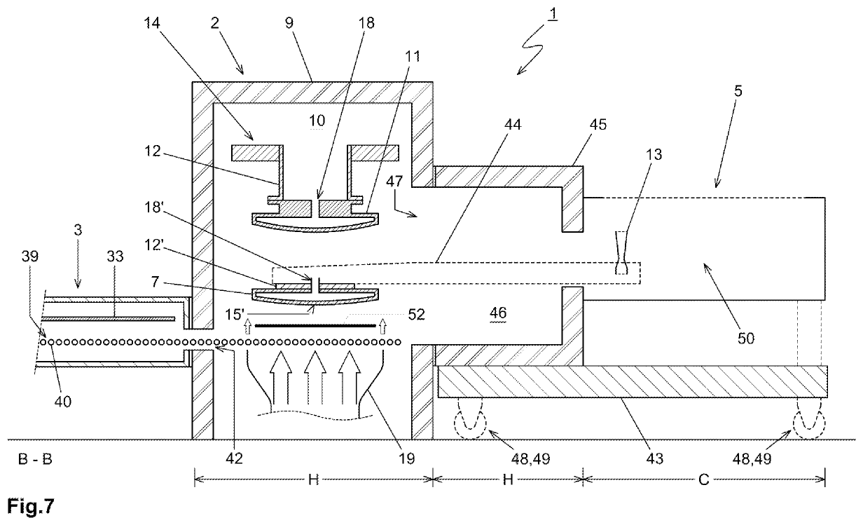

FIG. 7 depicts the device 1 for bending sheets at a later time than in FIG. 6. The sheet 52 is raised from the removal position in the direction of the transportable mold 7 by blowing with the fluid flow of a gaseous fluid, here, for example, an air flow 55 (symbolically represented by arrows) vertically generated by the blowing device 19 on its underside and finally pressed by the air flow 55 against its contact surface 15′. The transportable mold 7 has been lowered, for this purpose, far enough that the sheet 52 can be pressed against the contact surface 15′ by the air flow 55.

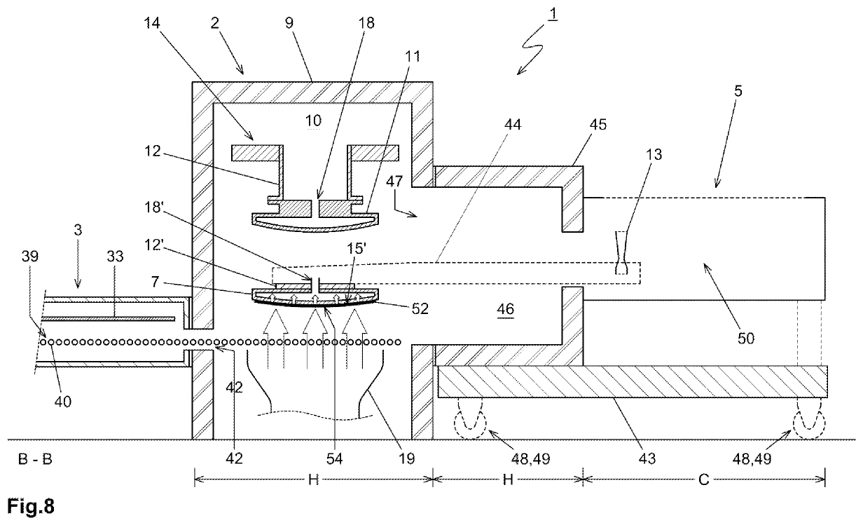

FIG. 8 depicts the device 1 for bending sheets at a later time than in FIG. 7. The sheet 52 is pressed against the contact surface 15′ by the air flow 55. In addition, the sheet 52 is fixed on the contact surface 15′ by suction by means of the suction/blowing device 18′. The suction/blowing device 18′ temporarily fixes the sheet 52 against the contact surface 15′ by means of a vacuum. This is depicted symbolically in FIG. 8 by arrows pointing upward.

As a result of the typically incomplete contact against the contact surface 15′, a pre-bending of the sheet 52 occurs only in the edge region 53. Generally, the pressing pressure from the air flow 55 is not sufficient to produce edge final bending in the edge region 53 of the sheet 52. On the other hand, the sucking action of the suction/blowing device 18′ serves substantially only for holding the sheet 52 against the contact surface 15′ until the press frame 8 has traveled under the sheet 52 should and has only a slight influence on the bending of the sheet 52. Nevertheless, bubbles in the sheet 52 can be removed thereby. In the inner region 54 of the sheet 52, only pre-bending of the surface is still possible as result of the contact surface 15′. FIG. 8 depicts a situation in which the sheet 52 is already fixed against the contact surface 15′.

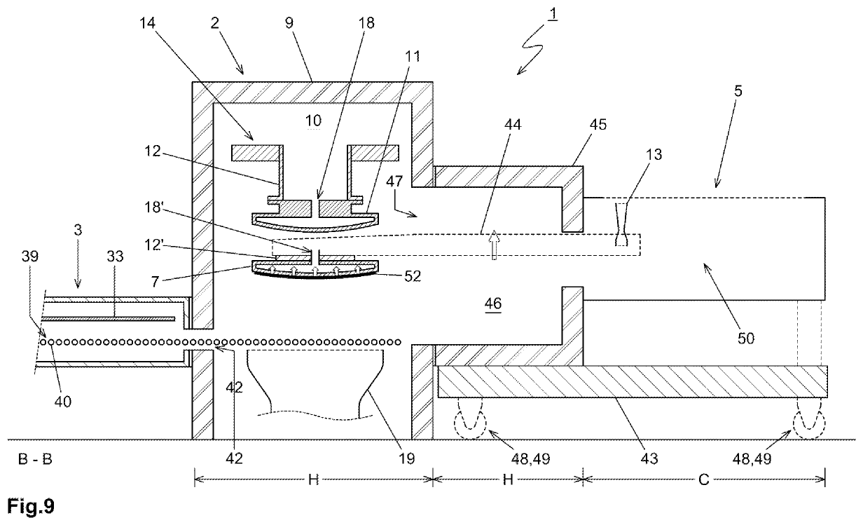

FIG. 9 depicts the device 1 for bending sheets at a later time than in FIG. 8. The air flow 55 coming from below has been stopped. The sheet 52 is fixed against the contact surface 15′ only by the negative pressure generated by the suction/blowing device 18′. The mold carrier 44 with the transportable mold 7 and the sheet 52 fixed thereon has been moved upward vertically.

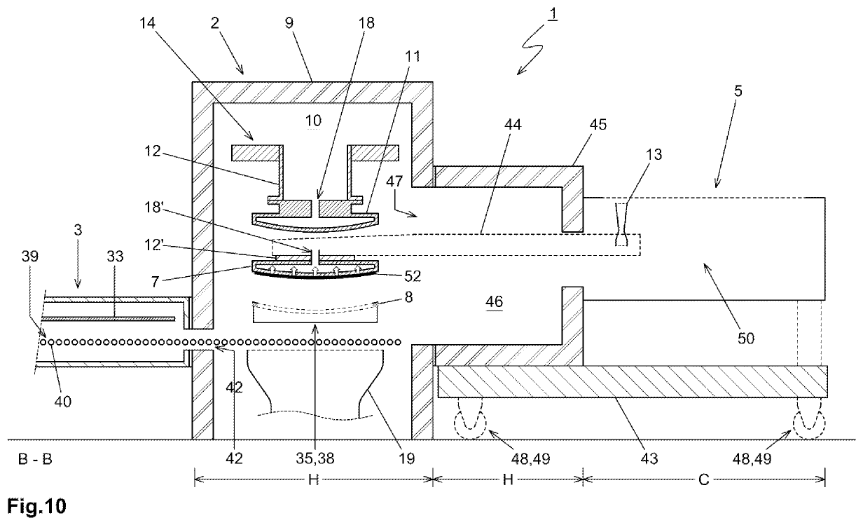

FIG. 10 depicts the device 1 for bending sheets at a later time than in FIG. 9. Depicted here is a situation in which the press frame 8 has been moved vertically into the press frame working position 38 directly below the sheet 52 (direction of movement in FIG. 10: into the plane of the drawing). The mold carrier 44 with the transport mold 7 and the sheet 52 fixed thereon is still situated in an elevated position.

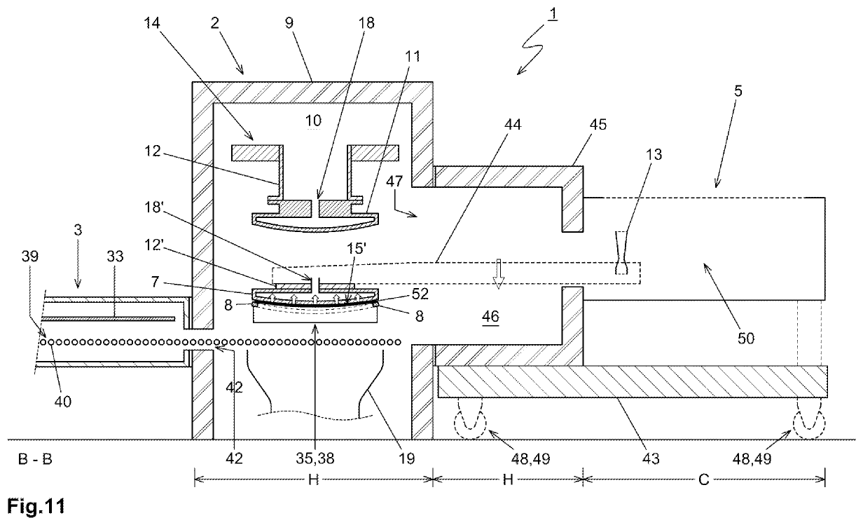

FIG. 11 depicts the device 1 for bending sheets at a later time than in FIG. 10. The transportable mold 7 has been brought, by lowering the mold carrier 44 vertically downward from the elevated position, to a lowered position, in which the sheet 52 fixed against the contact surface 15′ has areal contact with the press frame 8.

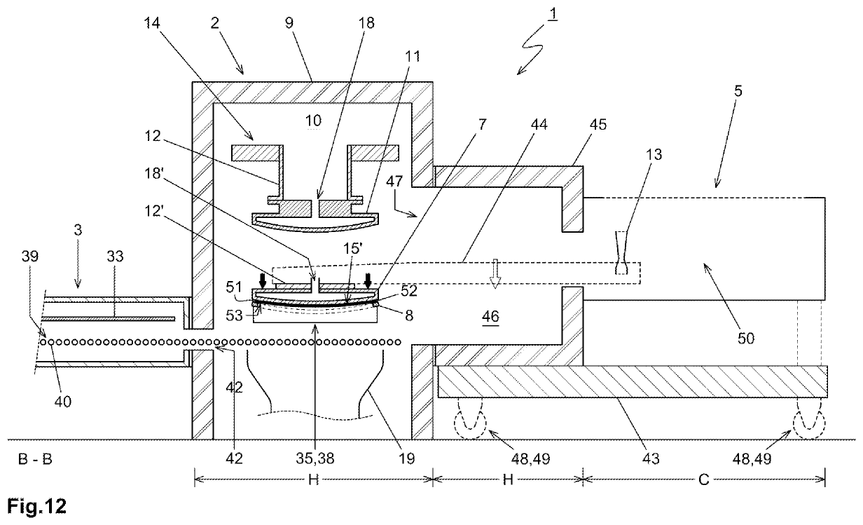

FIG. 12 depicts the device 1 for bending sheets at a later time than in FIG. 11. The sheet 52 is now placed on the press frame 8. To assist this, the sheet 52 is blown on by a stream of a gaseous fluid generated by means of the suction/blowing device 18′. Thus, undesired adhesion of the sheet 52 on the contact surface 15′ can be avoided. The press surface 51 preferably has a shape complementary to the outer surface section 16′ of the contact surface 15′. Optionally, the sheet 52 can be pressed between the contact surface 15′ of the transportable mold 7 and the press frame 8, illustrated here by downward pointing arrows. The sheet 52 is pressed in the edge region 53 between the outer surface section 16′ of the contact surface 15′ and the press surface 51 of the press frame 8 (see FIGS. 21A and 21B). On the press frame 8, the edge region 53 of the sheet 52 is pre-bent or finish bent passively by its own weight as well as, optionally, actively by pressing. A major advantage of pressing the sheet 52 against the press frame 8 is a resultant very precise definition of the position of the sheet 52 on the press frame 8 with exact contact of the edge region 53 of the sheet 52 on the press surface 51 of the press frame 8. This enables precise positional fixing of the sheet 52 on the press frame 8 by stoppers abutting the sheet 52 (not shown in detail). Thus, particularly high production accuracy and good optical quality of the bent sheet can be achieved. The fixing of the sheet 52 on the contact surface 15′ was released by stopping the suction action of the suction/blowing device 18′.

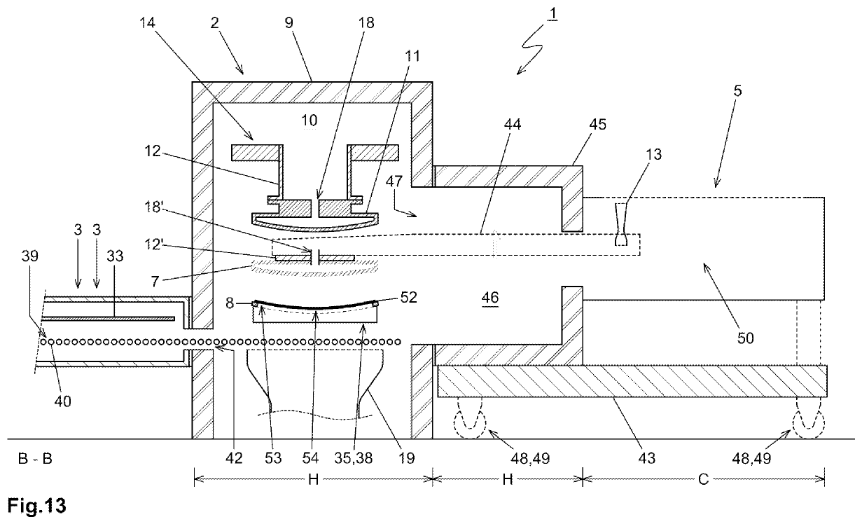

FIG. 13 depicts the device 1 for bending sheets at a later time than in FIG. 12. The mold carrier 44 and, with it, the transportable mold 7 has been moved vertically upward. During storage on the press frame 8, the sheet 52 is additionally passively pre-bent by its own weight in the inner region 54. If pressing occurs in the edge region 53, the surface pre-bending by gravity im inner region 54 can be restricted.

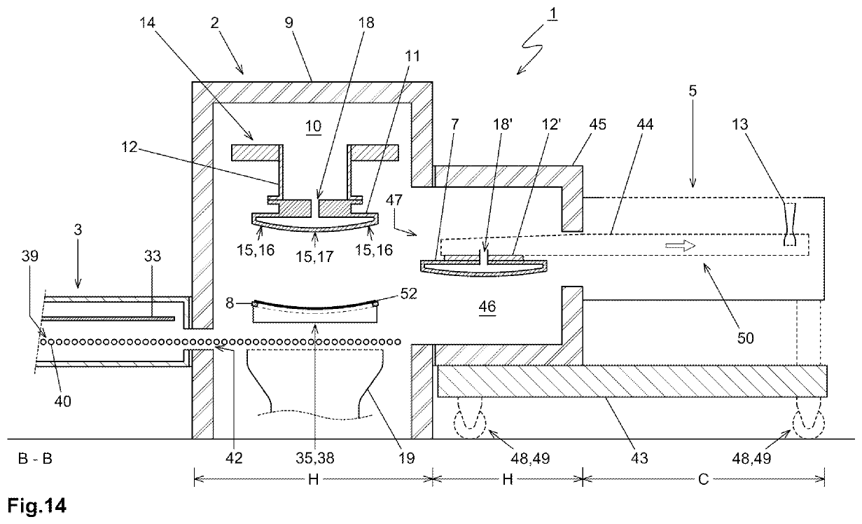

FIG. 14 depicts the device 1 for bending sheets at a later time than in FIG. 13. The sheet 52 is still stored on the press frame 8. The mold carrier 44 has been moved back horizontally from the bending chamber 2 into the mold carrier module 5, with the transportable mold 7 situated within the mold carrier module cavity 46.

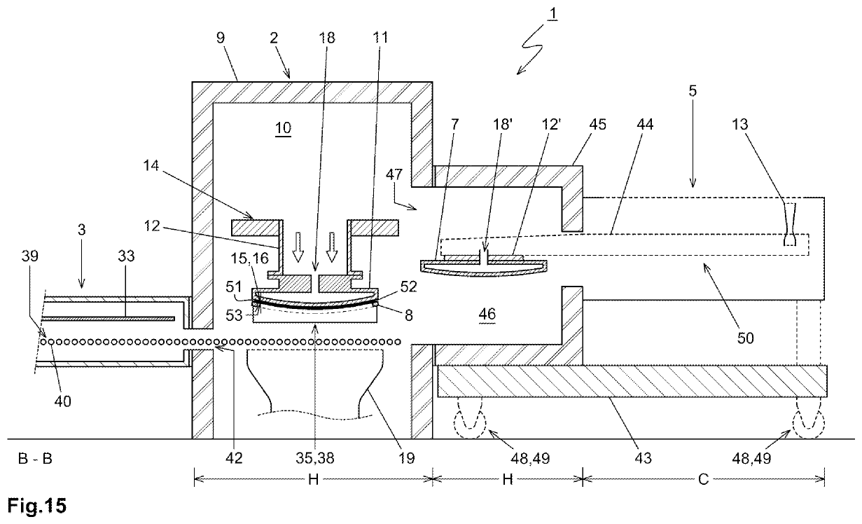

FIG. 15 depicts the device 1 for bending sheets at a later time than in FIG. 14. The stationary mold 11 has been lowered vertically onto the sheet 52, which rests on the press frame 8, and pressed in the edge region 53 between the outer surface section 16 of the contact surface 15 and the press surface 51 of the press frame 8. The press surface 51 has a shape complementary to the outer surface section 16 of the contact surface 15. The edge region 53 of the sheet 52 is thereby preferably finish bent, i.e., obtains its edge final bending. However, it is also possible for the edge region 55 of the sheet 52 to be (further) pre-bent. During storage of the sheet 52 on the press frame 8, the press frame 8 is not moved such that there is no risk of sheet 52 changing position on the press frame 8 and sheets 52 with particularly high quality can be produced.

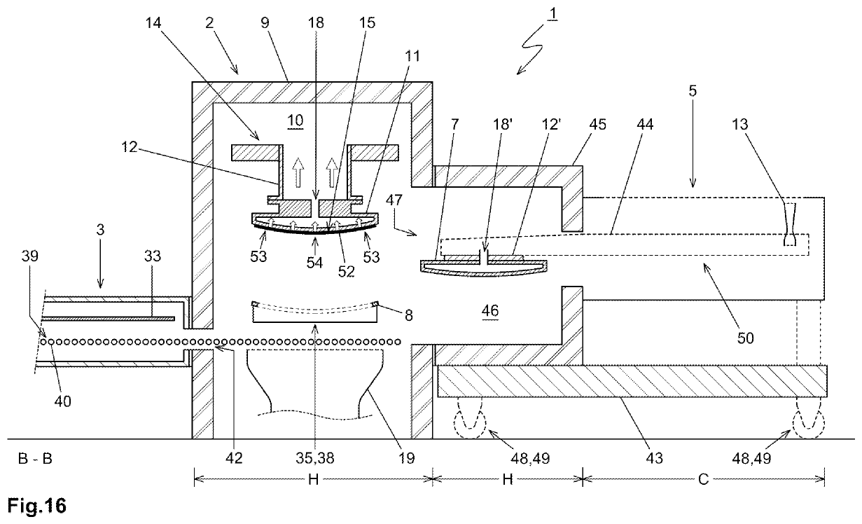

FIG. 16 depicts the device 1 for bending sheets at a later time than in FIG. 15. After pressing, the sheet 52 is fixed on the contact surface 15 of the stationary mold 11 by suction by means of the suction/blowing device 18. The fluid flow generating negative pressure on the contact surface 15 is represented symbolically by arrows. FIG. 16 depicts a situation in which the stationary mold 11 with a sheet 52 fixed thereon has been moved upward vertically. In contrast to the transportable mold 7, where, for example, the intention is only to hold the sheet 52 and the negative pressure, consequently, does not cause bending (at least not appreciably) of the sheet 52, the suction of the sheet 52 against the contact surface 15 can also be used to bend the sheet 52, i.e., the suction generates sufficient mechanical pressure to bend the sheet 52 in the manner desired. The sheet 52 can thus be pre-bent against the contact surface 15 in the inner region. In addition, previously produced edge final bending in the edge region 53 can be maintained on the sheet 52.

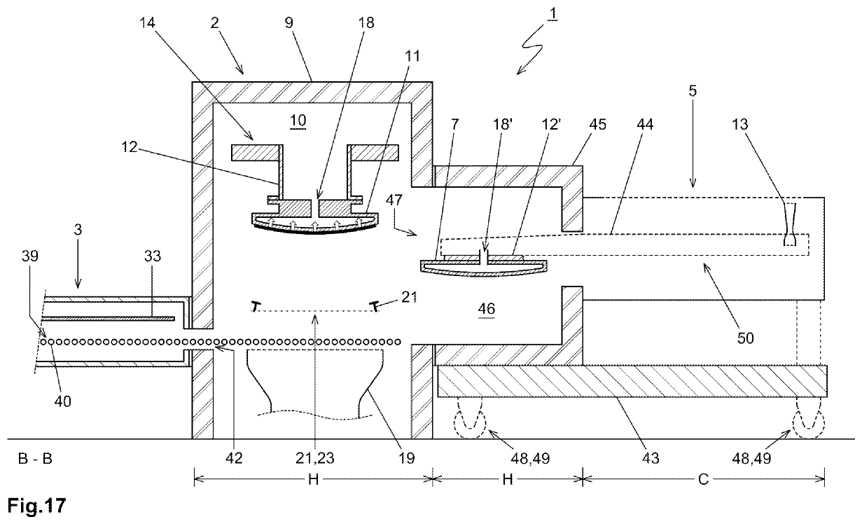

FIG. 17 depicts the device 1 for bending sheets at a later time than in FIG. 16. FIG. 17 depicts a situation in which the press frame 8 has been moved by moving the press frame carrier 35 in a horizontal plane from the press frame working position 38 within the bending chamber 2 into the press frame resting position 37 within the press frame module cavity 27 of the press frame module 5. The tempering frame 21 has been moved from the first tempering frame position 22 between the two tempering boxes 20 into the second tempering frame position 23 within the bending chamber 2. The second tempering frame position 23 is situated directly below the stationary mold 11 vertically. To enable entry into the bending chamber 2, the first bending chamber door 25 was opened for a short time, as a result of which an appreciable temperature loss can be avoided.

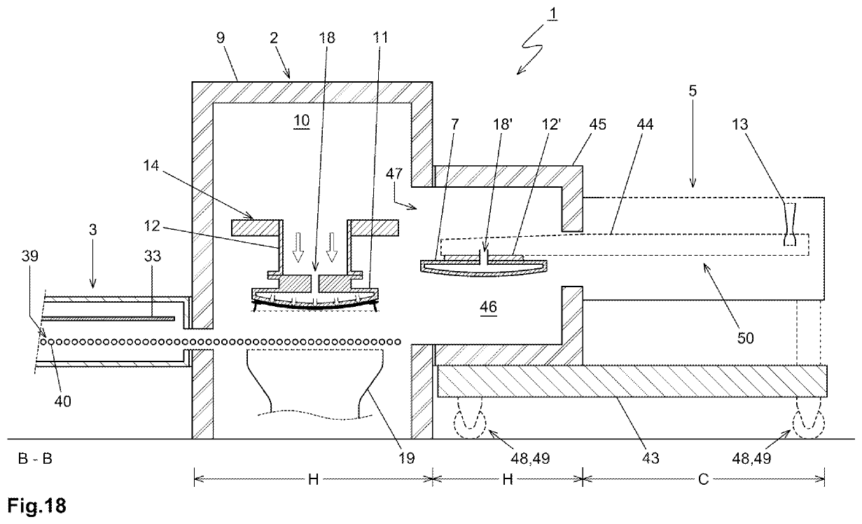

FIG. 18 depicts the device 1 for bending sheets at a later time than in FIG. 17. Here, the stationary mold 11 with a sheet 52 fixed thereon has been moved downward vertically, whereby the sheet 52 is placed on the tempering frame 21. The fixing of the sheet 52 on the contact surface 15 was released by stopping the suction action of the suction/blowing device 18. The placing of the sheet 52 is assisted by blowing with a fluid flow generated by means of the suction/blowing device 18.

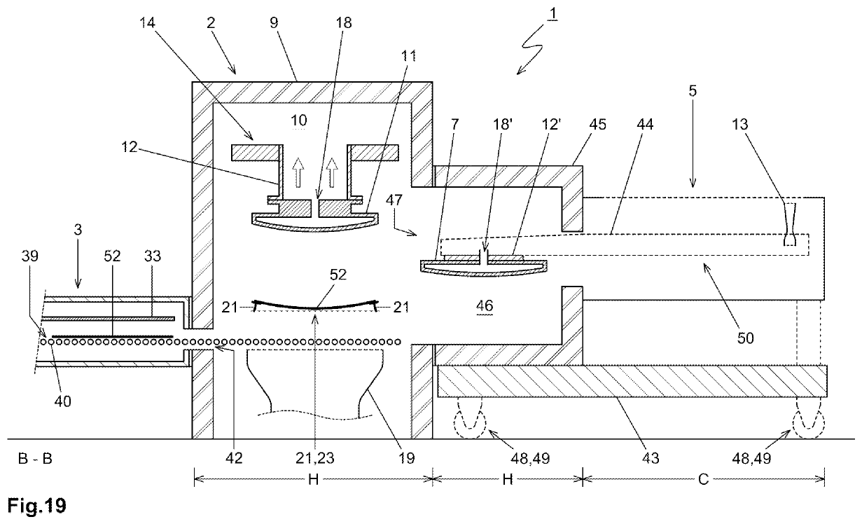

FIG. 19 depicts the device 1 for bending sheets at a later time than in FIG. 18. FIG. 19 depicts a situation in which the stationary mold 11 has been moved upward vertically. The sheet 52 is placed on the tempering frame 21.

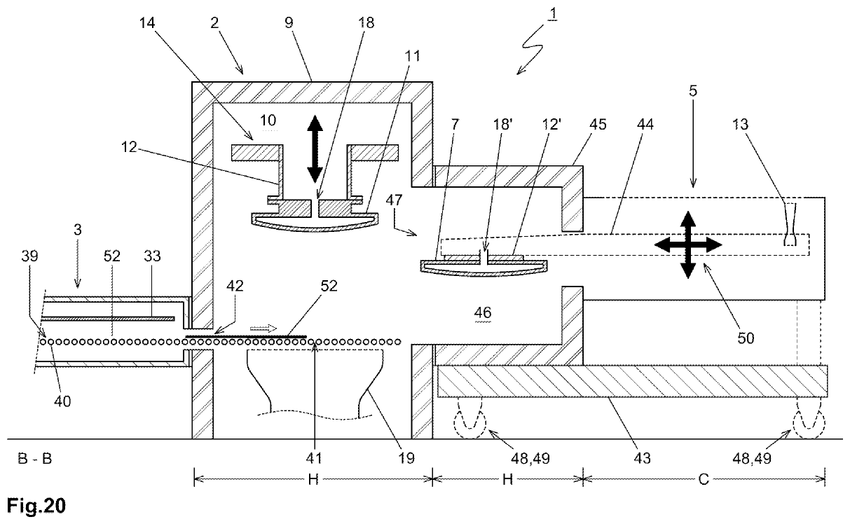

FIG. 20 depicts the device 1 for bending sheets at a later time than in FIG. 19. Here, the sheet 52 on the tempering frame 21 has been moved from the second tempering frame position 23 within the bending chamber 2 into the first tempering frame position 22 between the two tempering boxes 20, where the sheet 52 is tempered. In order to allow the tempering frame 21 with the sheet 52 placed thereon to leave the bending chamber 2, the first bending chamber door 25 was opened for a short time, as a result of which an appreciable temperature loss can be avoided. Edge final bending and surface final bending of the sheet 52 by gravity can be done during transport on the tempering frame 21. For this purpose, the tempering frame 21 preferably has an upward directed frame surface for contact with the sheet 52, which is suitably designed for edge final bending. In addition, the tempering frame 21 is preferably suitably designed for surface final bending by gravity.

As shown in FIG. 20, another sheet 52, which has been heated to a temperature suitable for bending, can now be transported into the bending chamber 2. The situation of FIG. 20 is similar to the situation of FIG. 4. In this manner, the bending process can be carried out continuously.

FIG. 22 illustrates the successive steps of an exemplary method for producing the sheet 52 by means of the device 1 with reference to a flow chart.

Here, in a first step I, a sheet 52 heated to bending temperature is provided in the removal position within the bending chamber 2. In a second step II, the sheet 52 is fixed on the contact surface 15′, 15 of a mold, selected from the transportable mold 7 and the stationary mold 11. In a third step III, the press frame 8 is positioned in the press frame working position 38 within the bending chamber 2. In an optional fourth step IV, pressing can be done between the contact surface 15′, 15 of the mold 7, 11, on which the sheet 52 is fixed, and the press frame 8. In a fifth step V, the sheet 52 is placed on the press frame 8. In a sixth step VI, the sheet 52 is pressed between the contact surface 15, 15′ of the respective other (not selected in step II) mold 7, 11 and the press frame 8. In a seventh step VII, the sheet 52 is fixed on the contact surface 15, 15′ of the mold 11, 7, with which the pressing was last done. In an eighth step VIII, the tempering frame 21 is positioned in the second tempering frame position 23 in the bending chamber 2. In a ninth step IX, the sheet 52 is placed on the tempering frame 21. In a tenth step X, the sheet 52 is transported on the tempering frame 21 to the tempering zone 4 for thermal tempering of the sheet 52.

According to a first alternative, in which the transportable mold 7 is used for the first fixing of the sheet 52 and the stationary mold 11 is used for the second fixing of the sheet 52, the transportable mold 7 is introduced into the bending chamber before the fixing of the sheet 52 on its contact surface 15′ and is removed again from the bending chamber 2 after the placing of the sheet 52 on the press frame 8. In contrast to this, the stationary mold 11 remains permanently in the bending chamber 2 at least from the provision of the sheet 52 in the bending chamber 2 until the transporting of the sheet 52 on the tempering frame 21.

According to a second alternative, in which the stationary mold 11 is used for the first fixing of the sheet 52 and the transportable mold 7 is used for the second fixing of the sheet 52, the transportable mold 7 is introduced into the bending chamber 2 after placing the sheet 52 on the press frame 8 and is removed from the bending chamber 2 after placing the sheet 52 on the tempering frame 21. In this case, the stationary mold 11 remains permanently in the bending chamber 2 at least from the provision of the sheet 52 in the bending chamber 2 until the transporting of the sheet 52 on the tempering frame 21.

From the above statements, it emerges that the invention enables fast and economical production even of complexly curved sheets. Existing systems for bending sheets can easily be retrofitted with the transportable mold introduced into the bending chamber from outside. The insertion and removal of the transportable mold make room for the use of the stationary mold, i.e., processing of sheets by multiple molds is made possible in a simple manner. In particular, the quality of the sheets can be further improved if a change in position of the molds occurs only vertically and the sheets are not moved during storage on the press frame. In this connection, the accuracy of the positioning of the sheet on the press frame by the pressing of the sheet between the mold and the press frame in the edge region of the sheet is particularly advantageous. The transportable mold that can be introduced into the bending chamber from the outside can be positioned within the bending chamber with particularly high accuracy. This is true in particular when a movement mechanism for the mold carrier is arranged outside a heated region. In addition, the molds can be exchanged and/or serviced quickly and easily. Particularly advantageously, the transportable mold can be heated before use such that the processing of sheets can be carried out quickly, in particular after a mold change. The invention thus enables particularly economical production of, in particular, complexly shaped sheets with relatively short cycle times and particularly high quality requirements.

### LIST OF REFERENCE CHARACTERS

1 device
2 bending chamber
3 preheating zone
4 tempering zone
5 mold carrier module
6 press frame module
7 transportable mold
8 press frame
9 bending chamber wall
10 bending chamber cavity
11 stationary mold
12 holder
13 Venturi device
14 holder movement mechanism
15, 15′ contact surface
16, 16′ outer surface section
17, 17′ inner surface section
18, 18′ suction/blowing device
19 blowing device
20 tempering box
21 tempering frame
22 first tempering frame position
23 second tempering frame position
24 first bending chamber opening
25 first bending chamber door
26 press frame module wall
27 press frame module cavity
28 press frame module opening
29 press frame module door
30 second bending chamber opening
31 second bending chamber door
32 press frame module movement mechanism
33 preheating zone heating device
34 press frame module heating device
35 press frame carrier
36 press frame carrier movement mechanism
37 press frame resting position
38 press frame working position
39 roller bed
40 roller
41 removal position
42 third bending chamber opening
43 substructure
44 mold carrier
45 mold carrier module wall
46 mold carrier module cavity
47 fourth bending chamber opening
48 mold carrier module movement mechanism
49 wheel
50 mold carrier movement mechanism
51 press surface
52 sheet
53 edge region
54 inner region
55 air flow

1. A method for bending sheets, comprising:
fixing a sheet is fixed in a bending chamber on a contact surface of a transportable mold; and
placing the sheet by the transportable mold onto a frame, wherein the transportable mold is introduced into the bending chamber before the fixing of the sheet in the bending chamber without the sheet fixed on the transportable mold and is removed from the bending chamber after the placing of the sheet onto the frame without the sheet fixed on the transportable mold.

2. The method according to claim 1, which comprises the following steps:
providing the sheet in the bending chamber,
fixing the sheet on a contact surface of a first mold within the bending chamber,
positioning a press frame in the bending chamber,
placing the sheet on the press frame,
pressing the sheet between a contact surface of a second mold and the press frame,
fixing the sheet on the contact surface of the second mold,
positioning a tempering frame in the bending chamber,
placing the sheet on the tempering frame,
transporting the sheet on the tempering frame to a cooling device for thermal tempering of the sheet,
wherein
i) the first mold is introduced into the bending chamber before the fixing of the sheet on its contact surface without the sheet fixed on the first mold and is removed from the bending chamber after the placing of the sheet on the press frame without the sheet fixed on the first mold, or
ii) the second mold is introduced into the bending chamber before the fixing of the sheet on its contact surface without the sheet fixed on the second mold and is removed from the bending chamber after the placing of the sheet on the tempering frame without the sheet fixed on the second mold.

3. The method according to claim 2, wherein the press frame is not moved after the placing of the sheet on the press frame and the pressing of the sheet by the second mold.

4. The method according to claim 2, wherein the sheet in the fixed state on the first mold and/or the second mold is moved only vertically.

5. The method according to claim 2, wherein the sheet is pressed between the contact surface of the first mold and the press frame.

6. The method according to claim 2, which comprises steps i), steps ii), or step iii):
Steps i)
first edge pre-bending of the sheet in an edge region by resting the sheet on the press frame and, optionally, by pressing the sheet between the contact surface of the first mold and the press frame,
second edge pre-bending of the sheet in the edge region by pressing the sheet between the second mold and the press frame,
edge final bending of the sheet in the edge region by resting the sheet on the tempering frame,
Steps ii)
edge pre-bending of the sheet in an edge region by resting the sheet on the press frame and, optionally, by pressing the sheet between the contact surface of the first mold and the press frame,
edge final bending of the sheet in the edge region by pressing the sheet between the second mold and the press frame,
Step iii)
edge final bending of the sheet in an edge region by pressing the sheet between the first mold and the press frame.

7. The method according to claim 2, wherein the sheet resting on the press frame resting sheet is subjected to surface pre-bending by gravity in an inner region surrounded by an edge region.

8. The method according to claim 2, wherein the sheet resting on the tempering frame is subjected to surface final bending by gravity in an inner region of the sheet surrounded by an edge region.

9. The method according to claim 2, wherein, before the placing of the sheet on the press frame, the press frame is introduced into the bending chamber; and after the fixing of the sheet on the contact surface of the second mold, the press frame is removed from the bending chamber.

10. A device for bending sheets for carrying out the method according to claim 1, comprising:
a bending chamber that is adapted to be heated to a temperature suitable for bending sheets,
at least one stationary mold with a contact surface for fixing a sheet, which at least one stationary mold is permanently arranged in the bending chamber during a period of time in which one and the same sheet is situated in the bending chamber,
at least one transportable mold with a contact surface for fixing a sheet, which at least one transportable mold is at times arranged outside the bending chamber during a period of time in which one and the same sheet is situated in the bending chamber, wherein the at least one transportable mold is fastened on a movable mold carrier and is adapted to be introduced into the bending chamber and is adapted to be removed from the bending chamber by moving the movable mold carrier, wherein the at least one transportable mold serves for being introduced into the bending chamber without a sheet fixed on the at least one transportable mold and for being removed from the bending chamber without a sheet fixed on the at least one transportable mold.

11. The device according to claim 10, wherein the movable mold carrier is mounted on a mold carrier module arranged outside the bending chamber.

12. The device according to claim 11, wherein the mold carrier module has a heatable mold carrier module cavity for receiving the transportable mold.

13. The device according to claim 12, wherein a mold carrier movement mechanism for moving the mold carrier is arranged at least partially outside the heatable mold carrier module cavity and/or which has a cooling device for cooling the mold carrier.

14. The device according to claim 10, which comprises:
a press frame for pressing a sheet, wherein the molds and the press frame are movable vertically relative to one another such that a sheet is pressable between a respective contact surface of the molds and a press surface of the press frame,
a tempering zone with a cooling device for thermal tempering of a sheet,
a tempering frame for transporting a sheet from the bending chamber to the tempering zone.

15. The device according to claim 10, comprising:
a pneumatic suction/blowing device associated with each of the molds for fixing a sheet on the contact surface by suction and/or for removing a sheet fixed on the contact surface by blowing, and/or
a pneumatic blowing device for lifting and pressing a sheet against the contact surface of a mold by blowing.

16. The device according to claim 11, wherein the mold carrier module is adapted to be delivered to the bending chamber.
